(19) United States
(12) Patent Application Publication
(10) Pub. No.: US 2015/0130429 A1
(43) Pub. Date: May 14, 2015

(54) FEEDING APPARATUS AND FEEDING METHOD

(71) Applicant: Kabushiki Kaisha Toshiba, Tokyo (JP)

(72) Inventor: Yutaka Horie, Mitaka (JP)

(21) Appl. No.: 14/537,715

(22) Filed: Nov. 10, 2014

Related U.S. Application Data
(60) Provisional application No. 61/904,302, filed on Nov. 14, 2013.

(51) Int. Cl. H02M 3/156; H02M 1/08

(52) U.S. Cl. CPC H02M 3/1563; H02M 1/08
USPC 323/271

(57) ABSTRACT

A feeding apparatus feeds an electric power to an object to which the electric power is fed. The feeding apparatus includes a DC/DC converter and a driver. The DC/DC converter outputs a PWM signal. The driver feeds the electric power to the object to which the electric power is fed in accordance with the PWM signal. The DC/DC converter outputs a prescribed voltage value during a Tri-State shift.

### CROSS-REFERENCE TO RELATED APPLICATION

This application claims priority from U.S. Provisional Patent Application No. 61/904,302 filed on Nov. 14, 2013, the entire contents of which are incorporated herein by reference.

### FIELD

The present invention relates to a feeding apparatus and a feeding method.

### BACKGROUND

As a technical background of the present invention, following points are considered, that a controller part which controls a voltage stabilization of a DC/DC converter circuit and a driver part which switches a power system are designed by different ICs due to an easy construction of a layout and a PWM (pulse width modulation) signal line as a switching control signal connected to both the ICs is made to have a high impedance due to a saving of electric power.

When the impedance of the driver part is high so far, after the PMW signal of the controller side is opened at the time of turning off a power source, the driver becomes a Tri-State, so that a delay time is lengthened until an operation is stopped. Thus, since a problem of an overshoot or undershoot arises in an output voltage to apply a damage to a load device, such a measure needs to be made as to lower the impedance of the PWM signal by adding an external circuit.

### BRIEF DESCRIPTION OF THE DRAWINGS

FIG. 1 is a perspective view showing one example of an external appearance of an electronic device of an embodiment.

FIG. 2 is a block diagram showing one example of a system structure of the electronic device of the embodiment.

FIG. 3 is a functional block structure diagram for explaining main parts of the embodiment.

FIG. 4 is a flowchart showing one example of a processing method of the embodiment.

FIGS. 5A and 5B are timing charts of a process of the embodiment.

### DETAILED DESCRIPTION

According to one embodiment, a feeding apparatus feeds an electric power to an object to which the electric power is fed. The feeding apparatus includes a DC/DC converter and a driver. The DC/DC converter outputs a PWM signal. The driver feeds the electric power to the object to which the electric power is fed in accordance with the PWM signal. The DC/DC converter outputs a prescribed voltage value during a Tri-State shift.

Various Embodiments will be described hereinafter with reference to the accompanying drawings.

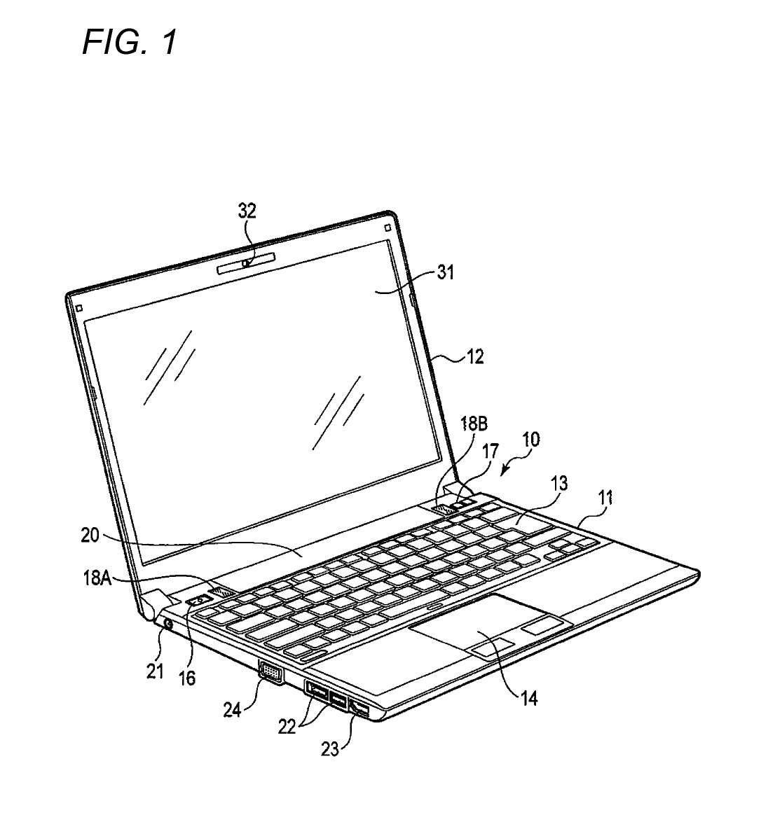

Now, an embodiment will be described below by referring to FIG. 1 to FIG. 5B.

Initially, by referring to FIG. 1 to FIG. 3, a structure of an electronic device according to one embodiment will be described below. The electronic device may be realized as, for instance, a notebook type portable personal computer, a tablet terminal or other various kinds of information processors.

FIG. 1 is a perspective view showing a notebook type computer 10 with a display unit opened from a front surface side. This computer 10 is formed so as to receive an electric power from a battery 20. The computer 10 includes a computer main body 11 and a display unit 12. In the display unit 12, a display device such as a liquid crystal display dev ice (LCD) 31 is incorporated. Further, in an upper end part of the display unit 12, a camera (a Web camera) 32 is arranged.

The display unit 12 is attached to the computer main body 11 so as to freely rotate between an opening position where an upper surface of the computer main body 11 is exposed and a closing position where the upper surface of the computer main body 11 is covered with the display unit 12. The computer main body 11 has a thin box shaped casing. On the upper surface thereof, are arranged a keyboard 13, a touch pad 14, a power switch 16 for switching on/off the computer 10, some functional buttons 17 and speakers 18A and 18B.

Further, in the computer main body 11, a power connector 21 is provided. The power connector 21 is provided in a side surface of the computer main body 11, for instance, a left side surface. To the power connector 21, an external power device is detachably connected. As the external power device, an AC adapter can be used. The AC adapter is a power device which converts a commercial power (an AC electric power) into a DC electric power.

The battery 20 is detachably attached to, for instance, a rear end part of the computer main body 11. The battery 20 may be a battery built in the computer 10.

The computer 10 is driven by the electric power from the external power device or the electric power from the battery 20. When the external power device is connected to the power connector 21 of the computer 10, the computer 10 is driven by the electric power from the external power device. Further, the electric power from the external power device is also used to charge the battery 20. During a period when the external power device is not connected to the power connector 21 of the computer 10, the computer 10 is driven by the electric power from the battery 20.

Further, in the computer main body 11, some USB ports 22, an HDMI (High Definition Multimedia Interface) output terminal 23 and an RGB port 24 are provided.

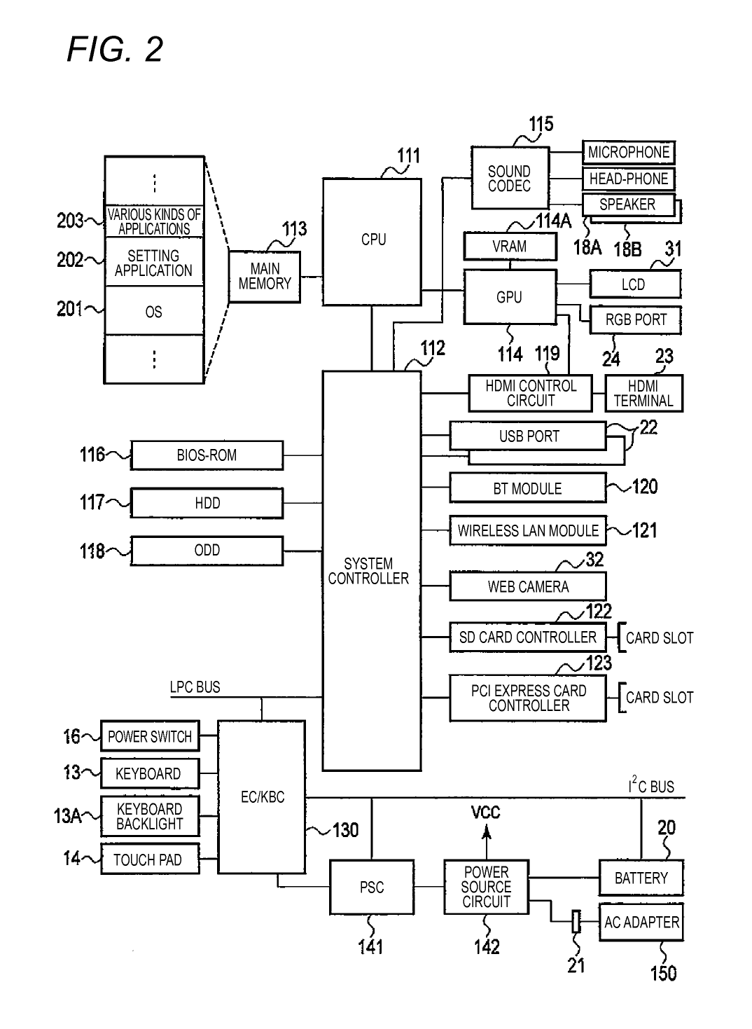

FIG. 2 shows a system structure of the computer 10. The computer 10 includes a CPU 111, a system controller 112, a main memory 113, a graphics processing unit (GPU)114, a sound CODEC 115 , a BIOS-ROM 116, a hard disk drive (HDD)117, an optical disk drive (ODD) 118, a BT(Bluetooth (a registered trademark)) module 120, a wireless LAN module 121, an SD card controller 122, a PCI EXPRESS card controller 123, an embedded controller/keyboard controller IC (EC/KBC) 130, a keyboard backlight 13A, a power source controller (PSC) 141 and a power circuit 142.

The CPU 111 is a processor which controls operations of components of the computer 10. The CPU 111 executes various kinds of software loaded in the main memory 113 from the HDD 117. The software includes a setting application program 202 whose explanation is omitted and various kinds of application programs 203 as well as an operating system (OS) 201. The various kinds of application programs 203 include applications of the above-described desk top system and an entire screen system.

Further, the CPU 111 also executes a basic input and output system (BIOS) stored in the BIOS-ROM 116 as a nonvolatile memory. The BIOS is a system program for controlling hardware.

The GPU 114 is a display controller which controls the LCD 31 used as a display monitor of the computer 10. The GPU 114 generates a display signal (an LVDS signal) to be supplied to the LCD 31 from display data stored in a video memory (a VRAM) 114A. Further, the GPU 114 can generate an analog RGB signal and an HDMI video signal from the display data. The analog RGB signal is supplied to an external display through the RGB port 24. The HDMI output terminal 23 can transmit the HDMI video signal (a non-compressed digital video signal) and a digital audio signal to the external display by one cable. An HDMI control circuit 119 is an interface which transmits the HDMI video signal and the digital audio signal to the external display through the HDMI output terminal 23.

The system controller 112 is a bridge device which connects the CPU 111 to the components respectively. The system controller 112 incorporates therein a serial ATA controller for controlling the hard disk drive (HDD) 117 and the optical disk drive (ODD) 118. Further, the system controller 112 communicates with devices respectively on an LPC (a Low PIN Count) bus.

The EC/KBC 130 is connected to the LPC bus. The EC/KBC 130, the power source controller (PSC) 141 and the battery 20 are mutually connected through a serial bus such as an I²C bus.

The EC/KBC 130 is an electric power management controller which manages an electric power of the computer 10 and is realized as, for instance, a one-chip microcomputer which incorporates therein a keyboard controller for controlling the keyboard (KB) 13 and the touch pad 14. The EC/KBC 130 has a function for switching on and switching off the computer 10 in accordance with an operation of the power switch 16 by a user. A control for switching on and switching off the computer 10 is carried out by a cooperating operation of the EC/KBC 130 and the power source controller (PSC) 141. When the power source controller (PSC) 141 receives an ON signal transmitted from the EC/KBC 130, the power source controller (PSC) 141 controls the power circuit 142 to switch on the computer 10. Further, when the power source controller (PSC) 141 receives an OFF signal transmitted from the EC/KBC 130, the power source controller (PSC) 141 controls the power circuit 142 to switch off the computer 10. The EC/KBC 130, the power source controller (PSC) 141 and the power circuit 142 are operated by an electric power from the battery 20 or an AC adapter 150 during a period when the computer 10 is turned off.

Further, the EC/KBC 130 can turn on/off the keyboard backlight 13A arranged in a rear surface of the keyboard 13. Further, the EC/KBC 130 is connected to a panel opening and closing switch 131 formed so as to detect opening and closing operations of the display unit 12. Even when the opening operation of the display unit 12 is detected by the panel opening and closing switch 131, the EC/KBC 130 can switch on the computer 10.

The power circuit 142 generates an electric power (an operating power) to be supplied to the components respectively by using the electric power from the battery 20 or the electric power from the AC adapter 150 connected to the computer main body 11 as an external power source.

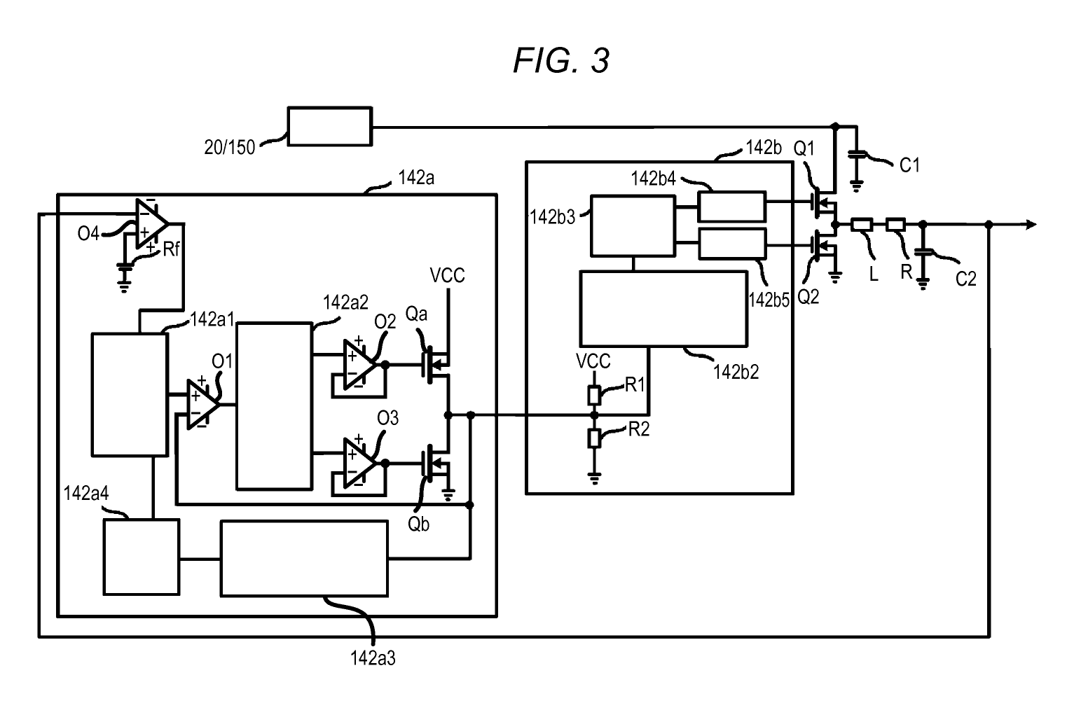

FIG. 3 is a functional block structure diagram for explaining main parts of the embodiment including the power circuit 142 as a center. A DC/DC converter IC 142a generates a PWM signal and transmits the PWM signal to a driver IC 142b.

The DC/DC converter IC 142a includes a PWM output control block 142a1, a PWM output drive block 142a2, a PWM voltage measuring block 142a3 and a PWM Tri-State voltage register 142a4. Further, the DC/DC converter IC 142a includes comparators O1 and O4, amplifiers O2 and O3 and N channel MOSFET Qa and Qb.

The driver IC 142b includes a PWM level discriminating block 142b2, a driver logic block 142b3, a high side FET driver block 142b4 and a low side FET driver block 142b5.

The PWM output control block 142a1 receives a feedback of an output obtained by comparing a signal derived from an output of the driver IC 142b with a reference voltage Rf by the comparator O4, outputs a PWM output of a rectangular wave and transmits the rectangular wave PWM output to the comparator O1. At the same time, the PWM output control block 142a1 generates a PWM output voltage of a rectangular wave and transmits the PWM output voltage to the comparator O1.

The comparator O1 converts the transmitted PWM output wave form into the transmitted PWM output voltage and outputs the PWM output voltage to the PWM output drive block 142a2.

The PWM output drive block 142a2 controls the N channel MOSFET Qa and Qb by using the amplifiers O2 and O3.

The PWM voltage measuring block 142a3 measures the voltage of the above-described output signal to send the voltage to the PWM Tri-State voltage register 142a4 as a PWM voltage level signal. The PWM Tri-State voltage register 142a4 is formed so as to send a Tri-State level signal based on the PWM voltage level signal to the PWM output control block 142a1.

Further, the PWM level discriminating block 142b2 discriminates a level of the PWM signal received by division resistances R1 and R2 from the DC/DC converter IC 142a to generate a driver control signal. The driver logic block 142b3 is formed so as to control the high side FET driver block 142b4 and the low side FET driver block 142b5 in accordance with the driver control signal.

When the high side FET driver block 142b4 and the low side FET driver block 142b5 are controller, Q1 is electrically conduced or not electrically conducted to Q2. C1 and C2 indicate capacitors for smoothing. A resistance R and an inductor L serve to stabilize an electric current from the battery 20 or the AC adapter 150.

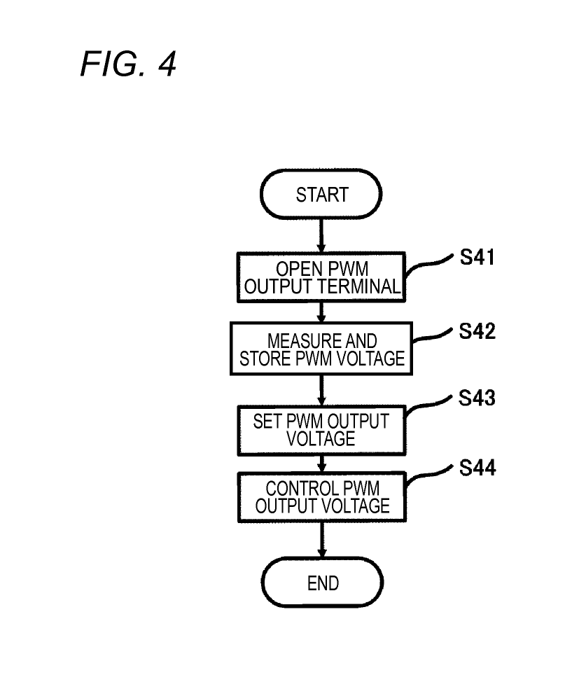

FIG. 4 is a flowchart showing one example of a processing method of the embodiment.
Step S41: The DC/DC converter IC 142a opens a PWM output terminal when a power source is activated so that a PWM signal voltage is allowed to be a Tri-State voltage determined by the resistances R1 and R2 in a PWM input terminal of the driver IC 142b.
Step S42: The PWM voltage measuring block 142a3 in the DC/DC converter IC 142a measures the above-described PWM voltage and stores the PWM voltage in the register.
Step S43: When the PWM output control block 1421a in the DC/DC converter IC 142a allows the PWM output to output to be a Tri-State, the PWM output control block 142a1 in the DC/DC converter IC 142a sets the PWM output voltage so that an output level thereof becomes a PWM Tri-State voltage stored in the PWM Tri-State voltage register 124a4.
Step S44: The PWM output drive block 142a2 in the DC/DC converter IC 142a controls a PWM output terminal voltage to become the set PWM output voltage.

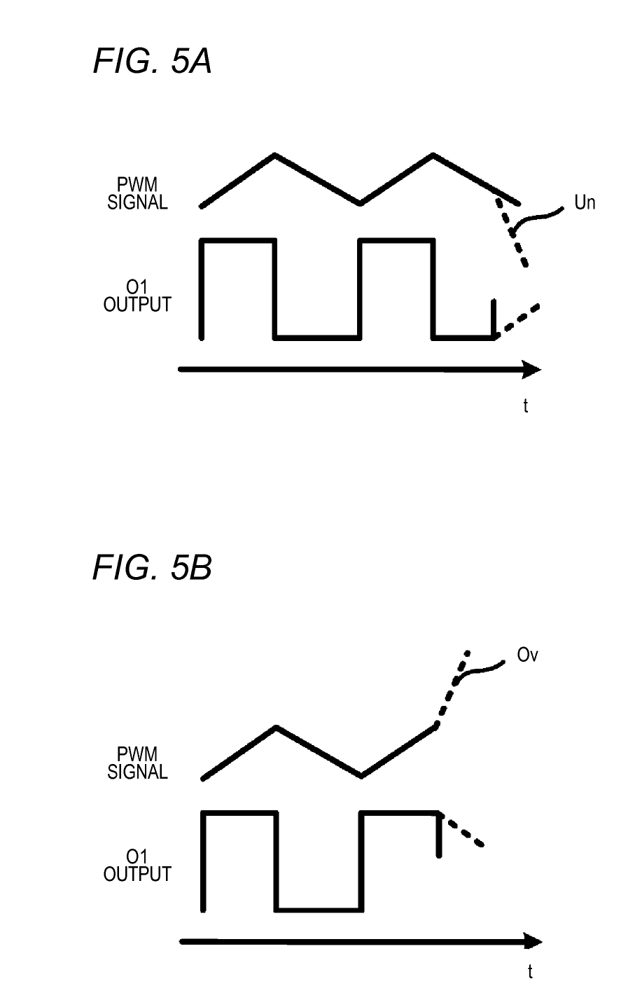

FIGS. 5A and 5B are timing charts of a process of the embodiment. An axis of abscissa shows an elapse of time t. FIG. 5A schematically shows a transition when a power source is tuned OFF if an output of the O1 is LOW. FIG. 5B schematically shows a transition when the power source is turned OFF if the output of the O1 is HIGH.

In FIG. 5A, in a usual case, when the output of the O1 gently rises from LOW as shown by a broken line, an undershoot Un shown by a broken line is generated in the PWM signal, however, in the present embodiment, both the output of the O1 and the PWM signal shift as shown by full lines.

In FIG. 5B, in the usual case, when the output of the O1 gently falls as shown by a broken line from HIGH, an overshoot Ov as shown by a broken line is generated in the PWM signal, however, in the present embodiment, both the output of the O1 and the PWM signal shift as shown by full lines.

When the DC/DC converter IC has a function for outputting a predetermined fixed value voltage (for instance, 1.7 V) during the Tri-State, the same functions as described above can be realized. 1. However, since a problem of compatibility may possibly arise that voltage levels of the DC/DC converter IC and the driver IC are not matched with each other, the above-described procedure, in which inner structures of the DC/DC converter are somewhat increased, more frequently effectively meets most of the cases.

In the above-described embodiment, since the circuit which measures a Tri-State voltage of the driver, the register which stores the measured voltage and the circuit which outputs the voltage value stored in the register in a low impedance during a shift to the Tri-State are added to the controller side, the problem of the overshoot or the undershoot of the output voltage which arises when the power source is turned off can be solved without adding an external circuit.

The external circuit has a low resistance for pulling up/pulling down the PWM signal having a value, for instance, 10 kilo-ohms or so and is relatively large in power loss.

The present invention is not limited to the above-described embodiment and may be variously modified and embodied within a range which does not deviate from a gist thereof.

Further, when a plurality of component elements disclosed in the above-described embodiment is suitably combined together, various inventions can be devised. For instance, some component elements may be deleted from all the component elements disclosed in the embodiment. Further, component elements of different embodiments may be suitably combined together.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A feeding apparatus which feeds an electric power to an object to which the electric power is fed, the feeding apparatus comprising:
a DC/DC converter that outputs a PWM signal; and
a driver that feeds the electric power to the object to which the electric power is fed in accordance with the PWM signal,
wherein the DC/DC converter outputs a prescribed voltage value during a Tri-State shift.

2. The feeding apparatus according to claim 1,
wherein the prescribed voltage value is a fixed value.

3. The feeding apparatus according to claim 1,
wherein the DC/DC converter has a circuit which measures a Tri-State voltage of the driver, and
the prescribed voltage value is a value of the Tri-State voltage.

4. The feeding apparatus according to claim 1,
wherein the prescribed voltage value is output in an impedance lower than an impedance during other periods except the time of the Tri-State shift.

5. A feeding method which feeds an electric power to an object to which the electric power is fed in a feeding apparatus, the feeding method comprising:
an output step that a DC/DC converter outputs a PWM signal; and
a feeding step that a driver feeds the electric power to the object to which the electric power is fed in accordance with the PWM signal,
wherein the DC/DC converter outputs a prescribed voltage value during a Tri-State shift.
